(19) United States
(12) Patent Application Publication
(10) Pub. No.: US 2003/0057022 A1
(43) Pub. Date: Mar. 27, 2003

(54) Hinge structure applied to folding ladder, stool and chair

(76) Inventor: Luhao Leng, Xiamen (CN)

Correspondence Address: RABIN & BERDO, P.C., Suite 500, 1101 14th Street, N.W., Washington, DC, 20005, US

(21) Appl. No.: 10/246,667

(22) Filed: Sep. 19, 2002

(30) Foreign Application Priority Data
Sep. 23, 2001 (CN) 01261854.3
Dec. 9, 2001 (CN) 01268963.7

(51) Int. Cl. E06C 1/00

(52) U.S. Cl. 182/165

(57) ABSTRACT

A hinge structure applied to folding ladder, stool and chair is provided, wherein the hinge structure is formed of a sleeve and two wings and is applied to a front frame and a back frame of the ladder, stool and chair so as to fixly secure a connecting hinge of the front frame connected to the hinge and a central of a rivet hole connected to the back frame, and the vertical length between the hinge and a axis of the frame is not smaller than the sum of the radiuses of the front frame tube and the back frame tube, thereby the folding chair is able to be opened easily and the folding volume thereof is reduce.

### BACKGROUND OF THE INVENTION

The invention is related to a hinge structure applied to folding ladder, stool and chair is provided, wherein the hinge structure is formed of a sleeve and two wings and is applied to a front frame and a back frame of the ladder, stool and chair so as to fixly secure a connecting hinge of the front frame connected to the hinge and a central of a rivet hole connected to the back frame, and the vertical length between the hinge and a axis of the frame is not smaller than the sum of the radiuses of the front frame tube and the back frame tube, thereby the folding chair is able to be opened easily and the folding volume thereof is reduce.

A conventional folding chair sold on the market is generally connected by inserted the bottom of the back frame into an aperture of the front frame, then a connecting shift is provided to connect the front frame and the back frame directly. Since the front frame and the back frame of the conventional folding chair are always wore down when the chair is opening and folding, the chair legs are damaged and the entire appearance is changed.

Further, the folding chair structure combined with a stool and a chair is a big development of a conventional chair. It is able to provide the stability of a ladder as well as a stool so as to achieve a stable climb and safety and the foldable feature as a normal folding chair simultaneously. The feature of modern economy is the integration of the world. As the production is concentrated and the volume and the cost are minimized, the concentrated production raises the cost of transportation and the storage cost and transportation occupy an extremely high percentage of the cost. Thus, it is necessary to minimize the volume of the production and increase the amount of the transportation and then reduce the cost of transportation.

It is therefore tried by the inventor to develop a hinge structure applied to folding ladder, stool and chair so as to solve the problem of the above-mentioned folding ladder, stool and chair, wherein the hinge structure is formed of a sleeve and two wings and is applied to a front frame and a back frame of the ladder, stool and chair so as to fixly secure a connecting hinge of the front frame connected to the hinge and a central of a rivet hole connected to the back frame, and the vertical length between the hinge and a axis of the frame is not smaller than the sum of the radiuses of the front frame tube and the back frame tube, thereby the folding chair is able to be opened easily and the folding volume thereof is reduce.

### SUMMARY OF THE INVENTION

It is the primary object of the present invention to provide a hinge structure applied to folding ladder, stool and chair that can completely connect a front frame and a back frame and fold them up under folding so as to minimize the folding volume.

It is another object of the present invention to provide a hinge structure which is capable of lengthening utility life and opening easily so as to reduce the entire thickness and volume of a folding chair with a triangular hinge and provide a hinge structure applied to folding ladder, stool and chair.

To achieve the above and other objects, a hinge structure applied to folding ladder, stool and chair is provided and is composed of a front frame, a back frame, a base, a connecting hinge and a retain portion of the back frame. The front frame is connected to the connecting hinge and a rivet is provided for fixing the connecting hinge to be a rotating hinge. The back frame is integrally connected to the connecting hinge through the retain portion of the back frame and a rotating hinge is formed therebetween. Then, the base, the front frame and the back frame are connected by the rivet and a rotating hinge is formed therein. It is characteristic in that the connecting hinge is a triangular connecting hinge and is formed of a sleeve and two wings, and the vertical length between a axis connected to the hinge hole, the retain portion of the back frame and a axis of the hole meet the two wings is not smaller than the sum of the radiuses of the front frame tube and the back frame tube, thereby the folding chair is able to be opened easily and the folding volume thereof is reduce.

### BRIEF DESCRIPTION OF THE DRAWINGS

The structure, feature and effect provided by the present invention to achieve the above and other objects can be best understood by referring to the following detailed description of the preferred embodiments and the accompanying drawings, wherein

FIG. 1a and FIG. 1b are a schematic view of the present invention respectively;

FIG. 2 is a schematic view of the first preferred embodiment of the present invention;

FIG. 3 is a schematic view that shows the opening and folding state of the first preferred embodiment of the present invention;

FIG. 4 is a schematic view that shows the opening state of the second preferred embodiment of the present invention;

FIG. 5 is a schematic view that shows the folding state of the second preferred embodiment of the present invention;

FIG. 6 is a schematic view that shows the opening state of the third preferred embodiment of the present invention;

FIG. 7 is a schematic view that shows the folding state of the third preferred embodiment of the present invention;

FIG. 8 is a schematic view that shows the opening state of the fourth preferred embodiment of the present invention; and

FIG. 9 is a schematic view that shows the folding state of the fourth preferred embodiment of the present invention.

### DETAILED DESCRIPTION OF THE PREFERRED EMBODIMENTS

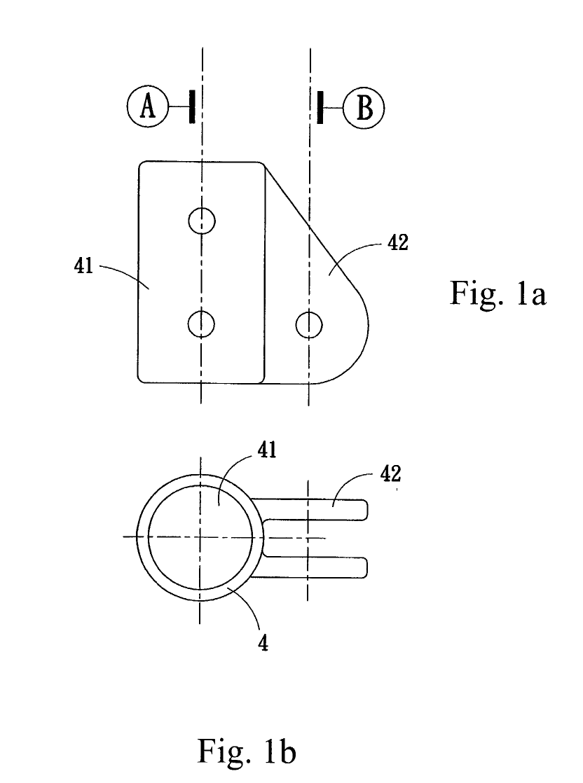

FIG. 1a and FIG. 1b are a schematic view of the present invention respectively. As shown, a connecting hinge 4 includes a sleeve 41 capable of connecting a front frame 1 and two wings connected to a retain portion 8 of a back frame 2.

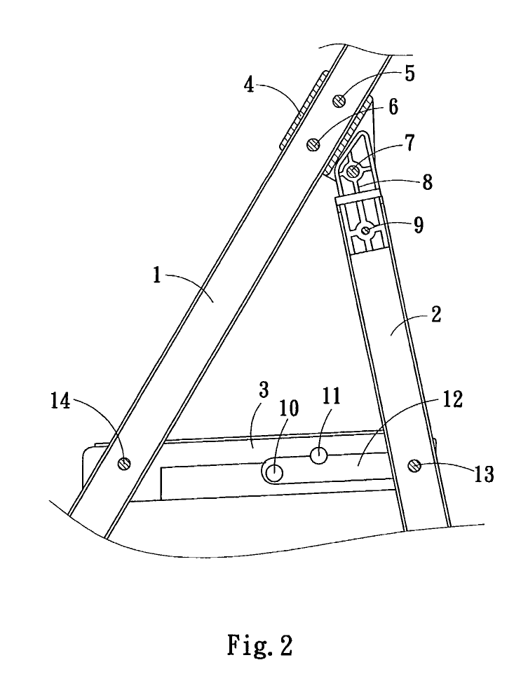

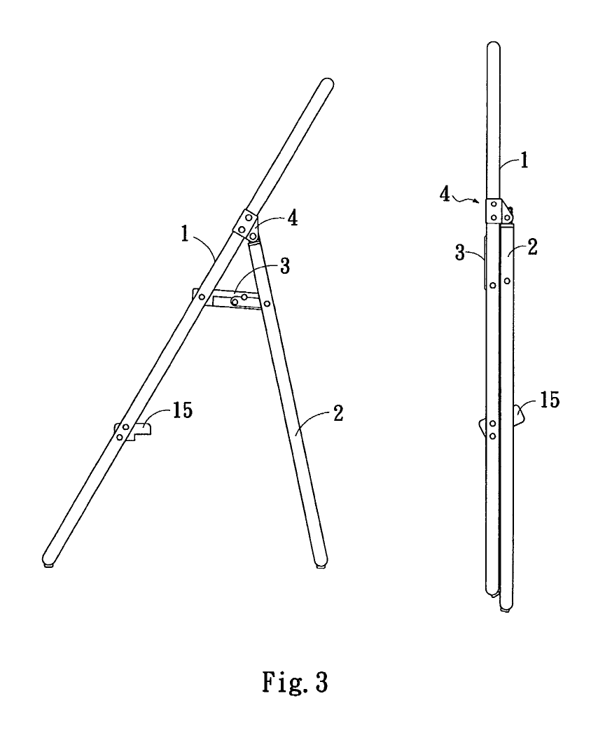

Please refer to FIG. 2 and FIG. 3 that shows a schematic view of the opening and folding state of the first preferred embodiment according to the present invention respectively. As shown, a step stool is composed of the front frame 1, the back frame 2 and a pedal 3. The front frame 1 and the pedal 3 are connected by a rivet 14. One end of a connecting hinge 4 is put into the front frame 1 and is fixed to the front frame 1 by rivets 5 and 6. The back frame 2 is connected to the retain portion 8 of the back frame 2 through a self-tapping screw 9. The connecting hinge 4 is connected to the retain portion 8 of the back frame 2 by a rivet 7. The portion of the back frame 2 in which the pedal 3 is disposed is connected to a connecting piece 12 by a rivet 13. The connecting piece 12 is rotatably connected to the pedal 3 by a rivet 10. In the above structure, the retain portion 8 and the connecting hinge 4 are connected to form a rotatable hinge by the rivet 7, the back frame 2 and the connecting piece 12 are connected to form a rotatable hinge by the rivet 13, the connecting piece 12 and the pedal 3 are connected to form a rotatable hinge by the rivet 10, and the pedal 3 and the front frame 1 are connected to a rotatable hinge by a rivet 14, so as to form a four-bar structure. A protrusive point 11 is disposed on the pedal 3. When the step stool is opening, the protrusive point 11 is able to lock the top of the connecting piece and enabling to function as a limitation. In addition. A pedal 15 is further disposed on the lower portion of the front frame 1 and is connected the lower end of the front frame 1. (A plurality of pedals are disposed according to the height of the step stool of present embodiment so as to satisfy the need of various height for climbing.)

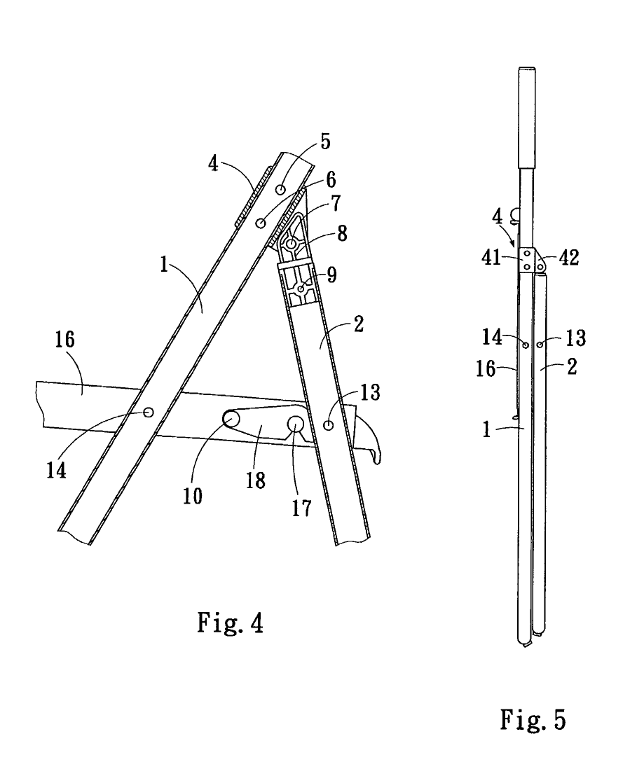

Please refer to FIG. 4 and FIG. 5 that shows a schematic view of the opening and folding state of the second preferred embodiment according to the present invention respectively. As shown, the connecting hinge is triangular hinge and is applied to a folding chair. The folding chair is provided and is composed of the front frame 1, the back frame 2, a base 16, the connecting hinge 4 and the retain portion 8 of the back frame 2. The front frame 1 is connected to the connecting hinge 4, and rivets 5, 6 are provided for fixing the connecting hinge 4 to the front frame 1. The back frame 2 is integrally connected to the connecting hinge 4 through the retain portion 8 of the back frame 2 and a rotating hinge is then formed therebetween. Thus, the base 16, the front frame 1 and the back frame 2 are connected by the rivets 13, 14 and the positions of the front frame 1 and the back frame 2 are limited by a connecting piece 18 and a protrusive point 17. By virtue of this arrangement, the front frame 1 and the back frame 2 are parallel to the base 16 when the folding chair is under folding, and thereby the folding volume of the folding chair is able to be minimized.

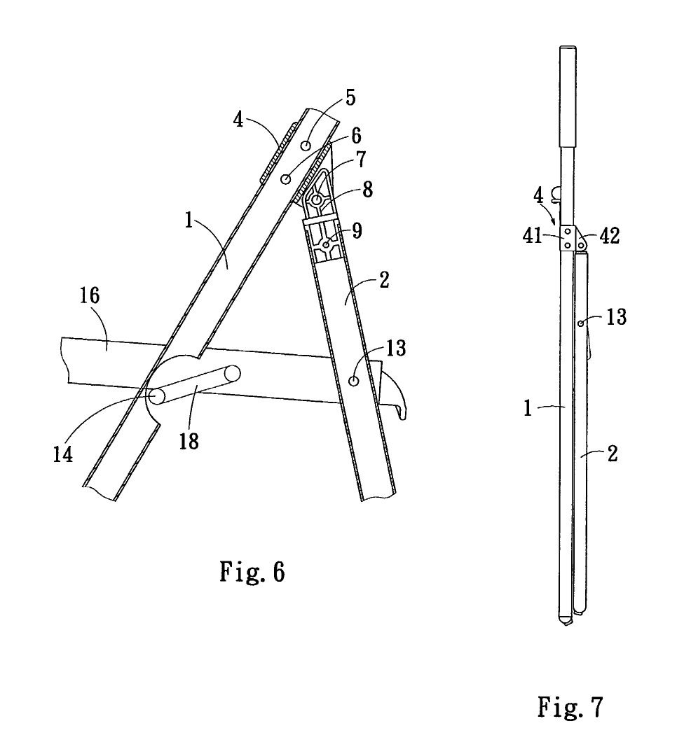

Please refer to FIG. 6 and FIG. 7 that shows a schematic view of the opening and folding state of the third preferred embodiment according to the present invention respectively. As shown, this embodiment is different to the second embodiment in that the connecting piece 18 is connected to the base 16 and the front frame 1 respectively and functions as a rotating hinge therebetween.

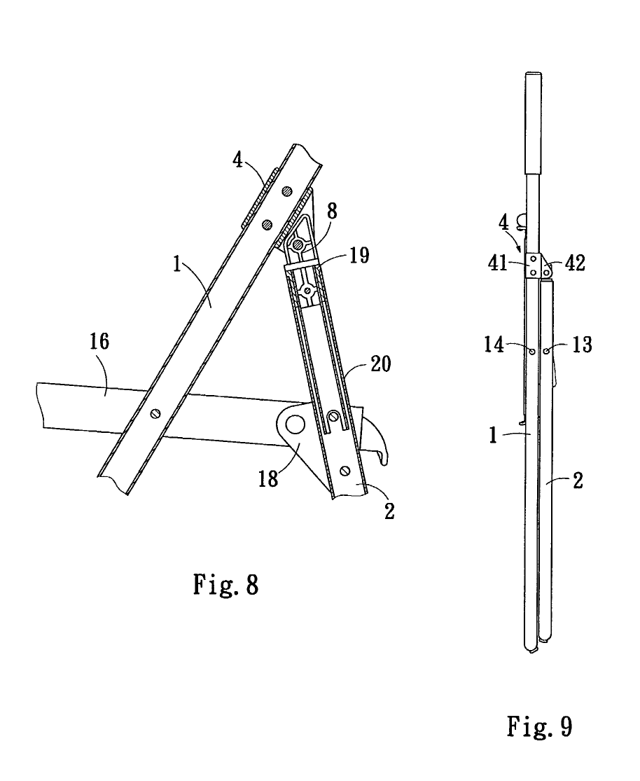

Please also refer to FIG. 8 and FIG. 9 that shows a schematic view of the opening and folding state of the fourth preferred embodiment according to the present invention respectively. As shown, this embodiment is different to the second embodiment in that a guide pillar 19 and a guide sheath 20 are disposed in the back frame 2, wherein the guide pillar 19 is slipped into the guide sheath 20 and a rotating hinge is formed between the guide pillar 19 and the retain portion 8 of the back frame 2 so as to allow the up and down slip of the guide pillar 19 within the back frame 2 and a protrusion of the retain portion 8 of the back frame 2 is able to limit the route of the guide pillar 19.

It is not intended, however, that the invention is limited to the particular embodiments described or to use in connection with the apparatus illustrated herein. Various modifications and alternative embodiments such as would ordinarily occur to one skilled in the art to which the invention relates are also contemplated and included within the meaning and range of equivalents of the appended claims.

What is claimed is:

1. An improvement structure of a step stool is comprising a front frame, a back frame and a pedal and is characteristic in that a connecting hinge is provided for connecting the front frame and the back frame of the step stool and is fixly secured the connecting hinge of the front frame and a central (datum B) of a rivet hole connected to the back frame, and the vertical length between the hinge and a axis (datum A) of the frame is not smaller than the sum of the radiuses of the front frame tube and the back frame tube.

2. The improvement structure of a step stool as claimed in claim 1, it is characteristic in that the back frame is integrally connected to a retain portion of the back frame through a self tapping screw and the front frame is integrally connected to a connecting hinge by a rivet, wherein the back frame and the connecting piece are connected to form a rotatable hinge by the rivet, the connecting piece and the pedal are connected to form a rotatable hinge by the rivet, and the pedal and the front frame are connected to form a rotatable hinge by a rivet 14 so as to form a four-bar structure.

3. The improvement structure of a step stool as claimed in claim 1, it is characteristic in that the step stool has a plurality of pedals.

4. A step stool with a triangular hinge is comprising a front frame, a back frame, a base, a connecting hinge and a retain portion of the back frame, wherein the front frame is connected to a connecting hinge and a rivet is provided for fixing the connecting hinge to the front frame, then the back frame is integrally connected to the connecting hinge through the retain portion of the back frame and a rotating hinge is then formed therebetween, thus the base, the front frame and the back frame are connected by the rivet and a rotating hinge is then formed therebetween; it is characteristic in that the connecting hinge is a triangular hinge and is formed of a sleeve and two wings, wherein the vertical length between a axis connected to the hinge hole of the connecting hinge, the retain portion of the back frame and a axis of the hole meet the two wings is not smaller than the sum of the radiuses of the front frame tube and the back frame tube.

5. The step stool with a triangular hinge as claimed in claim 4, it is characteristic in that the position of the base is limited by a connecting piece and a rivet and the base is connected to the base and the back frame respectively so as to form a rotatable hinge.

6. The step stool with a triangular hinge as claimed in claim 4, it is characteristic in that the position of the base is limited by a connecting piece and a rivet and the base is connected to the base and the front frame respectively so as to form a rotatable hinge.

7. The step stool with a triangular hinge as claimed in claim 4, it is characteristic in that the positions of the base is limited by a connecting piece and a protrusive point of the retain portion of the back frame and a rotatable hinge is formed between the connecting piece and the base, wherein the connecting piece is secured to the back frame and a guide sheath are disposed in the back frame and the guide pillar is slipped into the guide sheath and the guide pillar is fixed to the retain portion of the back frame.
